(19) United States
(12) Patent Application Publication
(10) Pub. No.: US 2024/0241002 A1
(43) Pub. Date: Jul. 18, 2024

(54) WIRELESS TELEMETRY DEVICE FOR COLLECTING WHEEL-RAIL FORCE SIGNALS

(71) Applicants: Guangzhou Metro Group Co., Ltd., Guangzhou (CN); Urban Rail Innovation Network Center Co., Ltd., Beijing (CN); CARS Engineering Consulting Corporation Limited (Beijing), Beijing (CN)

(72) Inventors: Jianlong Ding, Guangzhou (CN); Changjun Cai, Guangzhou (CN); Yougen Peng, Guangzhou (CN); Dongqiang Deng, Guangzhou (CN); Tao Tao, Guangzhou (CN); Haozhi Yuan, Guangzhou (CN); Xiangyu Ji, Beijing (CN); Lei Yang, Beijing (CN); Wenbin Wang, Beijing (CN); Shenglong Zhang, Beijing (CN); Kaiming Shen, Beijing (CN); Yuanting Dai, Beijing (CN); Zhiheng Wei, Beijing (CN); Tianhao Song, Beijing (CN); Bin Zhu, Beijing (CN)

(21) Appl. No.: 18/624,154

(22) Filed: Apr. 2, 2024

Related U.S. Application Data
(63) Continuation of application No. PCT/CN2022/126913, filed on Oct. 24, 2022.

(30) Foreign Application Priority Data
Jul. 1, 2022 (CN) 202210774456.8

(51) Int. Cl. G01L 5/16; G01M 17/08; G08C 17/02

(52) U.S. Cl. CPC G01L 5/16; G01M 17/08; G08C 17/02

(57) ABSTRACT

The present invention discloses a wireless telemetry device for collecting wheel-rail force signals, comprising: a wireless telemetry module, a power supply module, a signal transmission module and a controller. The wireless telemetry module is installed on a wheel axle of a train; a power supply output induction module is installed on a bogie of the train; a power supply receiving induction coil is installed on the wheel axle and electrically connected with the wireless telemetry module; a signal receiving induction module is installed on the bogie of the train; a signal output induction coil is installed on the wheel axle; the controller is installed on the bogie of the train; and the controller realizes signal connection with the signal receiving induction module. In the present invention, the wireless telemetry module and the controller can realize non-contact power transmission and signal transmission.

### TECHNICAL FIELD

The present invention relates to the field of detection for train tracks, and more particularly relates to a wireless telemetry device for collecting wheel-rail force signals.

### BACKGROUND

At present, detection methods for wheel-rail force can be divided into the ground test method and the vehicular test method according to the detection positions. The vehicular test method can conduct whole line measurement of line track states along with vehicles, and has unique technical advantages. The vehicular test method can also be divided into an instrumented wheelset method, an axonometry and an indirect measurement method. The instrumented wheelset method is the most widely used detection method for wheel-rail force in the urban railway system.

At present, the frequently-used detection system for wheel-rail force is usually carried on an operating electric passenger train or comprehensive detection train. The detection system mainly comprises an instrumented wheelset, a collector ring, a vibration acceleration sensor, a speed sensor, a signal collection device, an industrial control computer and supporting collection and analysis software. Strain gauges for detecting wheel-rail force are attached to one or more wheels of the instrumented wheelset.

In the traditional collection system for wheel-rail force, the instrumented wheelset and a data collection instrument are connected by the collector ring. The collector ring can lead out an electrical signal line generated by the strain gauges from the end of an axle, so that electrical signals can be exchanged between a rotating wheel and a fixed vehicular test system. However, a threading hole needs to be punched in the axle, thereby damaging the original structure of the axle. With the improvement of the intelligent operation and maintenance level of subways, the long-term online monitoring of wheel-rail force has become an urgent technical problem to be solved. The traditional detection system for wheel-rail force has the risk of fatigue failure after long-term online operation due to the damage to the existing wheelset structure.

Therefore, how to provide a wireless telemetry device for collecting wheel-rail force signals to overcome the above problems is a problem to be urgently solved by those skilled in the art.

### SUMMARY

In view of this, the present invention provides a wireless telemetry device for collecting wheel-rail force signals.

To achieve the above purpose, the present invention adopts the following technical solution:

A wireless telemetry device for collecting wheel-rail force signals is installed on a train for collecting wheel-rail force signals generated by strain gauges installed on wheels comprises:
a wireless telemetry module, which is installed on a wheel axle of the train;
a power supply module, wherein the power supply module comprises a power supply output induction module and a power supply receiving induction coil; the power supply output induction module is installed on a bogie of the train and can realize wireless electrical connection with the power supply receiving induction coil; and the power supply receiving induction coil is installed on the wheel axle and electrically connected with the wireless telemetry module;
a signal transmission module, wherein the signal transmission module comprises a signal receiving induction module and a signal output induction coil; the signal receiving induction module is installed on the bogie of the train and can realize wireless signal transmission with the signal output induction coil; and the signal output induction coil is installed on the wheel axle and realizes signal connection with the wireless telemetry module;
a controller, wherein the controller is installed on the bogie of the train and is electrically connected with the power supply output induction module, and the controller realizes signal connection with the signal receiving induction module.

According to the above technical solutions, compared with the prior art, the present invention discloses and provides a wireless telemetry device for collecting wheel-rail force signals. In the present invention, the wireless telemetry module is fixed on the wheel axle, and the arrangement ensures that the telemetry device can effectively collect wheel-rail force signals. The power supply receiving induction coil and the signal output induction coil for power transmission and signal transmission respectively with the wireless telemetry module are fixed on the wheel axle, and the power supply output induction module and the signal receiving induction module for wireless power transmission and wireless signal transmission respectively for the wireless telemetry module are installed on the train. The arrangement enables the wireless telemetry module and the controller to realize non-contact power transmission and signal transmission.

Preferably, the wireless telemetry device further comprises a telemetry tooling; the telemetry tooling comprises two semicircular connecting elements and two semicircular connecting plates; the ends of the two connecting elements are respectively fixed and the wheel axle is tightly clamped between the two connecting elements; a gap is provided on the outer wall of one connecting element; the wireless telemetry module is installed in the gap; the two connecting plates are respectively fixed with the two connecting elements; the plate surfaces of the two connecting plates are aligned and arranged perpendicularly to the wheel axle; the wheel axle is limited between the two connecting plates; the power supply receiving induction coil and the signal output induction coil are coaxially sleeved on the wheel axle; the two connecting plates are limited between the power supply receiving induction coil and the signal output induction coil; and the power supply receiving induction coil and the signal output induction coil are fixed with the two connecting plates. The arrangement ensures that the wireless telemetry module, the power supply receiving induction coil and the signal output induction coil can be reliably fixed on the wheel axle.

Preferably, the wireless telemetry device further comprises a protecting shell; one end of the protecting shell is open and is embedded in the gap; and the wireless telemetry module is arranged in a region limited jointly by the protecting shell and the connecting elements. The arrangement ensures that the wireless telemetry module can be reliably fixed with the connecting elements.

Preferably, the wireless telemetry device further comprises an installing rack and an induction box; the installing rack is fixed on a frame for rotatable support of the wheel axle; the induction box is fixed with the installing rack; and the power supply output induction module and the signal receiving induction module are limited in the induction box and the induction ends of the two correspond to the positions of the power supply receiving induction coil and the signal output induction coil respectively. The arrangement ensures that the power supply output induction module and the signal receiving induction module can be reliably fixed through the installing rack and the frame.

### DESCRIPTION OF DRAWINGS

To more clearly describe the technical solutions in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is an axonometric schematic diagram of a wireless telemetry device for collecting wheel-rail force signals;

FIG. 2 is an axonometric schematic diagram of a wireless telemetry device for collecting wheel-rail force signals installed on a frame;

FIG. 3 is an axonometric diagram of a wireless telemetry module in a wireless telemetry device for collecting wheel-rail force signals;

FIG. 4 is an axonometric diagram of a connecting element in a wireless telemetry device for collecting wheel-rail force signals; and

FIG. 5 is a schematic diagram of connection in a wireless telemetry device for collecting wheel-rail force signals.

In the drawings:

1 wireless telemetry module; 2 wheel axle; 3 wireless receiver; 4 vibration collection box; 5 induction power supply box; 6 110V DC power supply; 7 connecting element; 8 connecting plate; 9 protecting shell; 10 installing rack; and 11 induction box.

### DETAILED DESCRIPTION

The technical solutions in embodiments of the present invention will be clearly and fully described below. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

The present invention discloses a wireless telemetry device for collecting wheel-rail force signals. In the present invention, a wireless telemetry module 1 is fixed on a wheel axle, and the arrangement ensures that the telemetry device can effectively collect wheel-rail force signals. A power supply receiving induction coil and a signal output induction coil for power transmission and signal transmission respectively with the wireless telemetry module 1 are fixed on the wheel axle 2, and a power supply output induction module and a signal receiving induction module for wireless power transmission and wireless signal transmission respectively for the wireless telemetry module 1 are installed on a train. The arrangement enables the wireless telemetry module 1 and a controller to realize non-contact power transmission and signal transmission, without the need for drilling and threading on the wheel axle 2, to adapt to long-term online monitoring of the urban railway system. The wireless telemetry device of wheel-rail force is installed on an electric passenger train operated daily, which can avoid the problem of large workload caused by the traditional manual detection, can efficiently detect the wheel-rail force in the whole process for railway lines, can find transnormal and abnormal acting forces in time, accurately determine line defects and specific locations which affect operation safety and stability, thereby having important guiding significance for routine maintenance of the railway lines.

### EMBODIMENTS

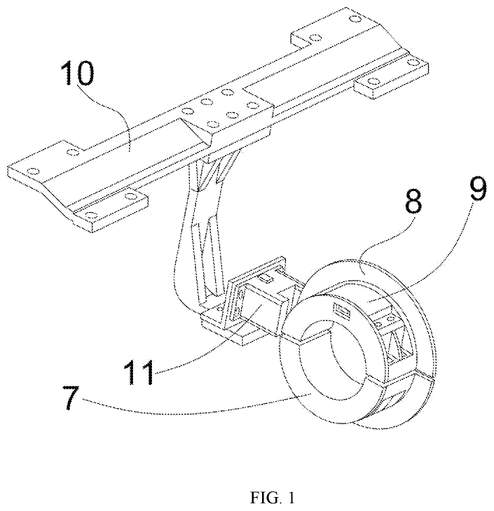

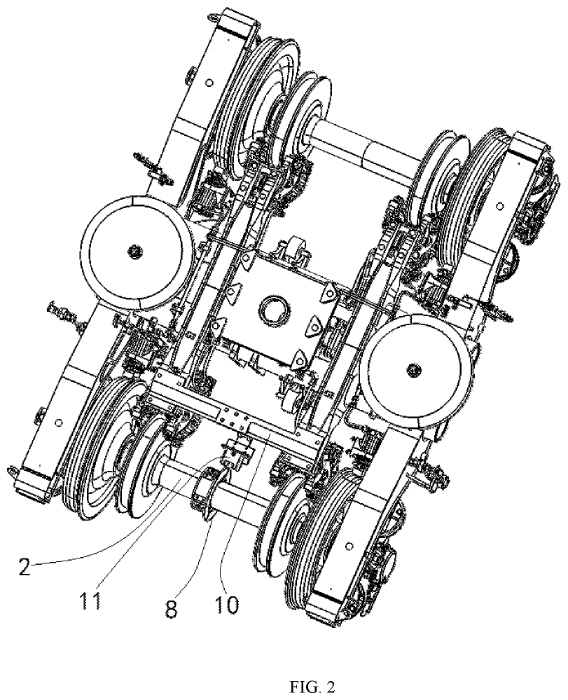

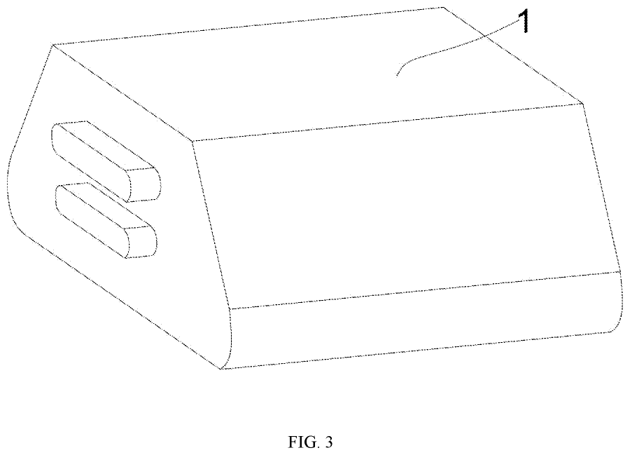

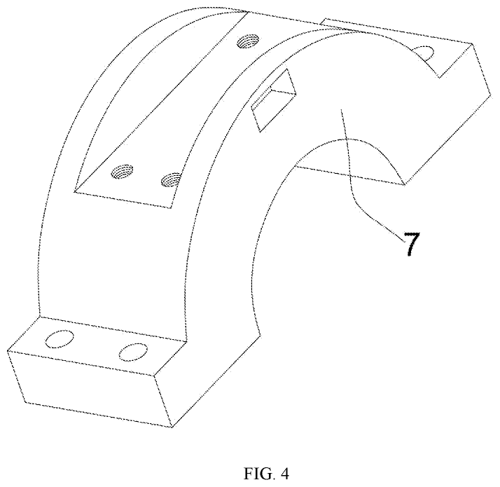

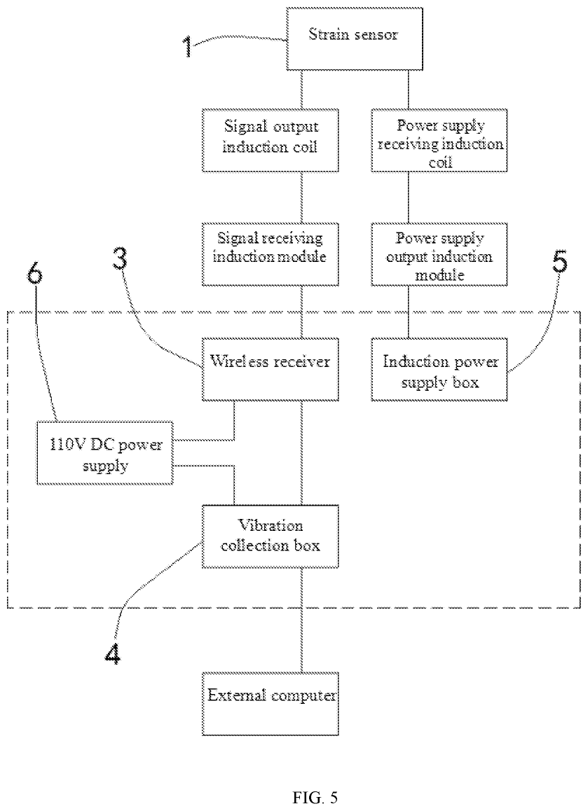

FIGS. 1-5 are overall and partial structural schematic diagrams of an embodiment of the present invention. The present invention specifically discloses a wireless telemetry device for collecting wheel-rail force signals, which is installed on a train for collecting wheel-rail force signals generated by strain gauges (not shown in the drawings) installed on wheels, comprising:
a wireless telemetry module 1, which is installed on a wheel axle 2 of the train, wherein the wireless telemetry module 1 and wireless signal transmission thereof with the strain gauges belong to the mature prior art and thus will not be specifically explained in detail in the present embodiment;
a power supply module, wherein the power supply module comprises a power supply output induction module and a power supply receiving induction coil adapted with the power supply output induction module; the power supply output induction module is installed on a bogie of the train and can realize wireless electrical connection with the power supply receiving induction coil; the power supply receiving induction coil is installed on the wheel axle 2 and electrically connected with the wireless telemetry module 1; and the power supply output induction module supplies power for the wireless telemetry module 1 through the power supply receiving induction coil;
a signal transmission module, wherein the signal transmission module comprises a signal receiving induction module and a signal output induction coil adapted with the signal receiving induction module; the signal receiving induction module is installed on the bogie of the train and can realize wireless signal transmission with the signal output induction coil; the signal output induction coil is installed on the wheel axle 2 and realizes signal connection with the wireless telemetry module 1; and the wireless telemetry module 1 realizes signal transmission through the signal output induction coil and the signal receiving induction module;
the power supply output induction module, the power supply receiving induction coil and the principle of wireless power transmission between the two, and the signal receiving induction module, the signal output induction coil and the principle of wireless signal transmission between the two belong to the mature prior art, and thus will not be specifically explained in detail in the present embodiment;
a controller, which is installed on the bogie of the train and comprises a wireless receiver 3, a vibration collection box 4, an induction power supply box 5 and a 110V DC power supply 6, wherein the induction power supply box 5 is electrically connected with the power supply output induction module so as to realize continuous power supply for the wireless telemetry module 1; the receiving end of the wireless receiver 3 is connected with the signal receiving induction module through a signal line, and the output end of the wireless receiver 3 is connected with the receiving end of the vibration collection box 4 through a signal line; signals sent by the wireless telemetry module 1 are transmitted to the vibration collection box 4 through the signal output induction coil, the signal receiving induction module and the wireless receiver 3 successively; the vibration collection box 4 transmits measurement signals to an external computer through Ethernet for analysis and processing; and the 110V DC power supply 6 is responsible for DC power supply for the wireless receiver 3 and the vibration collection box 4. The wireless receiver 3 and the vibration collection box 4 belong to the prior art, and thus will not be specifically explained in the present embodiment.

Further specifically, the wireless telemetry device further comprises a telemetry tooling; the telemetry tooling comprises two semicircular connecting elements 7 and two semicircular connecting plates 8; the ends of the two connecting elements 7 are respectively fixed through bolts and the wheel axle 2 is tightly clamped between the two connecting elements to ensure that the two connecting elements 7 may not rotate relative to the wheel axle 2 when the wheel axle 2 is operated at high speed; a gap is provided on the outer wall of one connecting element 7; the wireless telemetry module 1 is installed in the gap; the two connecting plates 8 are respectively fixed with the two connecting elements 7 through welding or bolt connection; the two connecting elements 7 can be spliced to form a circular pipe; the two connecting plates 8 can be spliced to form an annular plate; and the outer diameter of the spliced annular plate is greater than the outer diameter of the spliced circular pipe. The purpose of the arrangement is to facilitate the arrangement of the power supply receiving induction coil and the signal output induction coil. The plate surfaces of the two connecting plates 8 are aligned and arranged perpendicularly to the wheel axle 2; the wheel axle 2 is limited between the two connecting plates 8; the power supply receiving induction coil and the signal output induction coil are coaxially sleeved on the wheel axle 2; the two connecting plates 8 are limited between the power supply receiving induction coil and the signal output induction coil; and the power supply receiving induction coil and the signal output induction coil are fixed with the two connecting plates 8 through bonding.

Further specifically, the wireless telemetry device further comprises a protecting shell 9; one end of the protecting shell 9 is open, is embedded in the gap and is fixed with the connecting elements 7 through bolts; and the wireless telemetry module 1 is arranged in a region limited jointly by the protecting shell 9 and the connecting elements 7 and the detection end of the wireless telemetry module 1 is ensured to be arranged close to the wheel axle 2.

Further specifically, the wireless telemetry device further comprises an installing rack 10 and an induction box 11; the installing rack 10 is entirely in a shape of T, and two opposite ends are respectively fixed on a frame for rotatable support of the wheel axle 2 through bolts; the induction box 11 is fixed with one end of the installing rack 10; the power supply output induction module and the signal receiving induction module are limited in the induction box 11 and the induction ends of the two correspond to the positions of the power supply receiving induction coil and the signal output induction coil respectively; and reasonable clearances exist between the power supply output induction module and the power supply receiving induction coil and between the signal receiving induction module and the signal output induction coil.

The working process of the telemetry device is:

The wireless telemetry module 1 collects wheel-rail force signals, and then transmits the collected signals to an external computer through the signal output induction coil, the signal receiving induction module, the wireless receiver 3 and the vibration collection box 4 successively.

The induction power supply box 5 supplies power for the wireless telemetry module 1 through the power supply output induction module and the power supply receiving induction coil.

Each embodiment in the description is described in a progressive way. The difference of each embodiment from each other is the focus of explanation. The same and similar parts among all of the embodiments can be referred to each other.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

What is claimed is:

1. A wireless telemetry device for collecting wheel-rail force signals, which is installed on a train for collecting wheel-rail force signals generated by strain gauges installed on wheels, comprising:
a wireless telemetry module (1), which is installed on a wheel axle (2) of the train;
a power supply module, wherein the power supply module comprises a power supply output induction module and a power supply receiving induction coil; the power supply output induction module is installed on a bogie of the train and can realize wireless electrical connection with the power supply receiving induction coil; and the power supply receiving induction coil is installed on the wheel axle (2) and electrically connected with the wireless telemetry module (1);
a signal transmission module, wherein the signal transmission module comprises a signal receiving induction module and a signal output induction coil; the signal receiving induction module is installed on the bogie of the train and can realize wireless signal transmission with the signal output induction coil; and the signal output induction coil is installed on the wheel axle (2) and realizes signal connection with the wireless telemetry module (1);
a controller, wherein the controller is installed on the bogie of the train and is electrically connected with the power supply output induction module, and the controller realizes signal connection with the signal receiving induction module.

2. The wireless telemetry device for collecting wheel-rail force signals according to claim 1, further comprising a telemetry tooling, wherein the telemetry tooling comprises two semicircular connecting elements (7) and two semicircular connecting plates (8); the ends of the two connecting elements (7) are respectively fixed and the wheel axle (2) is tightly clamped between the two connecting elements; a gap is provided on the outer wall of one connecting element (7); the wireless telemetry module (1) is installed in the gap; the two connecting plates (8) are respectively fixed with the two connecting elements (7); the plate surfaces of the two connecting plates (8) are aligned and arranged perpendicularly to the wheel axle (2); the wheel axle (2) is limited between the two connecting plates (8); the power supply receiving induction coil and the signal output induction coil are coaxially sleeved on the wheel axle (2); the two connecting plates (8) are limited between the power supply receiving induction coil and the signal output induction coil; and the power supply receiving induction coil and the signal output induction coil are fixed with the two connecting plates (8).

3. The wireless telemetry device for collecting wheel-rail force signals according to claim 2, further comprising a protecting shell (9), wherein one end of the protecting shell (9) is open and is embedded in the gap; and the wireless telemetry module (1) is arranged in a region limited jointly by the protecting shell (9) and the connecting elements (7).

4. The wireless telemetry device for collecting wheel-rail force signals according to claim 2, further comprising an installing rack (10) and an induction box (11); the installing rack (10) is fixed on a frame for rotatable support of the wheel axle (2); the induction box (11) is fixed with the installing rack (10); and the power supply output induction module and the signal receiving induction module are limited in the induction box (11) and the induction ends of the two correspond to the positions of the power supply receiving induction coil and the signal output induction coil respectively.
